(19) United States
(12) Patent Application Publication
(10) Pub. No.: US 2009/0004484 A1
(43) Pub. Date: Jan. 1, 2009

(54) Resine Composition For Printed Circuit Board And Composite Substrate And Copper Laminates Using The Same

(75) Inventors: In Wook KIM, Seoul (KR); Duk Sang Han, Daejeon (KR); Kwang Suk Park, Yongin-si (KR); Soo Im Jung, Yongin-si (KR); Dong Ki Nam, Seongnam-si (KR)

Correspondence Address: SUGHRUE MION, PLLC, 2100 PENNSYLVANIA AVENUE, N.W., SUITE 800, WASHINGTON, DC, 20037, US

(73) Assignee: Doosan Corporation, Seoul (KR)

(21) Appl. No.: 12/146,621

(22) Filed: Jun. 26, 2008

(30) Foreign Application Priority Data
Jun. 26, 2007 (KR) 10-2007-0063200
Jun. 26, 2007 (KR) 10-2007-0063211

(51) Int. Cl. C08L 71/10; B32B 15/20; B32B 15/088; B32B 15/092; B32B 15/09; B32B 27/34; B32B 27/36; B32B 27/38; B32B 27/42

(52) U.S. Cl. 428/436; 525/396; 428/477.4; 428/480; 428/460

(57) ABSTRACT

Disclosed is a resin composition for a PCB, the composition including: (a) a polyphenylene ether resin modified via a redistribution reaction of polyphenylene ether in the presence of 9,9-bis(hydroxyaryl)fluorene or 9,10-dihydro-9-oxa-10-(dihydroxyaryl)-10-phosphaphenanthrene 10-oxide; (b) a dicyclopentadiene epoxy resin represented by Formula 1; and (c) an alkylphenol aldehyde novolak curing agent represented by Formula 2, wherein, when the polyphenylene ether resin is modified via a redistribution reaction of the polyphenylene ether in the presence of 9,9-bis(hydroxyaryl)fluorene, the composition further includes (d) a brominated epoxy resin. Also, a composite substrate and a copper laminate using the same are disclosed.

This is a non-provisional application which claims priority from Korean Patent Application 10-2007-0063200 filed Jun. 26, 2007, and Korean Patent Application 10-2007-0063211 filed on Jun. 26, 2007, all of which are incorporated herein by reference.

### BACKGROUND OF THE INVENTION

(a) Field of the Invention

The present invention relates to a resin composition for fabricating a printed circuit board having an excellent dielectric property, and a composite substrate and a copper laminate using the same.

(b) Description of the Related Art

As a printed circuit board (hereinafter, referred to as ‘PCB’), a laminate fabricated by layering a predetermined number of prepregs and subjecting the prepregs to a heat/pressure forming treatment has been conventionally used, each of the prepregs being obtained by impregnating a substrate, such as glass fabric, with an epoxy resin or polyimide, followed by drying. However, recently, as an electronic device has been miniaturized and has had high performance, a PCB has rapidly become highly dense and multi-layer structured. Accordingly, as an insulating substrate for such a PCB, a copper laminate fabricated by layering a predetermined number of prepregs and subjecting the prepregs to a heat/pressure forming treatment has been used, each of the prepregs being obtained by impregnating a substrate, such as glass fabric, with an epoxy resin or polyimide, followed by drying.

Meanwhile, in a recent electronic information device, such as a computer, an operating frequency increases by short-time treatment of a large amount of information, thereby increasing a transmission loss and a signal delay time. Accordingly, in order to solve such a problem, a copper laminate having characteristics, such as low permittivity and a low dielectric tangent (tan δ), has been required. In general, since a signal delay time in a PCB increases in proportion to the square root of relative permittivity (εr) of an insulating material in the vicinity of wiring, a resin composition having low permittivity is required for a board requiring a high transmission speed. However, a currently conventionally used copper laminate with FR-4 grade has relatively high permittivity of about 4.5 to 5.5, and thus there is a problem of an increase in transmission loss and signal delay time.

It is known that as a conventional resin composition for coping with such high frequency of a signal and improving the high frequency characteristics of a PCB, a combination of cyanate ester (which is a thermosetting resin having very low permittivity) and an epoxy resin has been used. Also, a method of using a thermoplastic resin, such as a fluororesin or a polyphenylene ether resin, etc., has been known.

However, in this technology, an epoxy resin used as a base material is insufficient to meet the high frequency characteristics due to its high permittivity. In addition, the increase of the ratio of a cyanate ester resin or a thermoplastic resin used for decreasing permittivity may cause a serious problem in that in the process of fabricating a PCB, the workability or processibility is largely reduced. Especially, in using a polyphenylene ether resin which is a thermoplastic resin, there is a problem in that the melt viscosity of a resin composition is increased, and the flowability is largely reduced. Accordingly, it is very difficult to fabricate a laminate through press molding by high temperature and high pressure, or to fabricate a multilayer printed wiring board in which grooves between micro circuit patterns are required to be filled up. Also, there is a problem in that adhesive strength with a copper foil and heat resistance are significantly reduced.

Meanwhile, a resin composition where an epoxy resin is combined with a phenol added butadiene polymer has been conventionally used to fabricate a laminate of which a dielectric property, heat resistance and moisture resistance are improved. However, due to high molecular weight of the phenol added butadiene polymer, in fabricating a prepreg by impregnating and drying a sheet type substrate with the resin composition, a large amount of bubbles may occur on the surface of the prepreg. As a result, voids may occur within the formed laminate, and thus the laminate may be inappropriate for use as an insulating substrate of a PCB.

Also, it has been reported that since the permittivity of E-glass used as a substrate for a conventional copper laminate with FR-4 grade is very high, a material having low permittivity, such as synthetic polyamide fiber, D-glass, or quartz has been used as a substrate. In such a case, in drilling a PCB, a drill may be significantly worn away, and particularly there is a problem in that fabrication cost for the PCB is increased.

### SUMMARY OF THE INVENTION

Therefore, the present invention has been made in view of the above-mentioned problems. The present invention provides a resin composition for a PCB, which has desirable formability and processibility, thereby preventing the occurrence of voids (caused by foaming) on a prepreg surface within a laminate and significantly improving physical properties, such as dielectric property, heat resistance, adhesive strength, etc.

Also, the present invention provides a composite substrate and a copper laminate using the resin composition.

In accordance with an aspect of the present invention, there is provided a resin composition for a PCB, the composition including: (a) a polyphenylene ether resin modified via a redistribution reaction of polyphenylene ether in the presence of 9,9-bis (hydroxyaryl)fluorene or 9,10-dihydro-9-oxa-10-(dihydroxyaryl)-10-phosphaphenanthrene 10-oxide; (b) a dicyclopentadiene epoxy resin represented by Formula 1; and (c) an alkylphenol aldehyde novolak curing agent represented by Formula 2, wherein, when the polyphenylene ether resin is modified via a redistribution reaction of the polyphenylene ether in the presence of 9,9-bis(hydroxyaryl)fluorene, the composition further includes (d) a brominated epoxy resin:

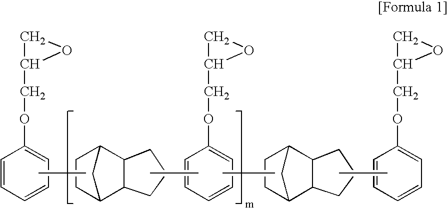

wherein m is an integer equal to or more than 0; and

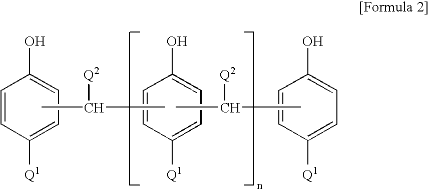

wherein Q¹ represents a C₁˜C₁₂ alkyl group, a C₅˜C₇ cycloalkyl group, or a C₆˜C₂₄ aromatic hydrocarbon group, Q² represents hydrogen or a C₁˜C₁₂ alkyl group, and n is an integer equal to or more than 0.

In accordance with another aspect of the present invention, there is provided a composite substrate formed by coating or impregnating a substrate with a resin composition for a PCB, followed by drying, the resin composition for the PCB including: (a) a polyphenylene ether resin modified via a redistribution reaction of polyphenylene ether in the presence of 9,9-bis(hydroxyaryl)fluorene or 9,10-dihydro-9-oxa-10-(dihydroxyaryl)-10-phosphaphenanthrene 10-oxide; (b) a dicyclopentadiene epoxy resin represented by Formula 1; and (c) an alkylphenol aldehyde novolak curing agent represented by Formula 2, wherein, when the polyphenylene ether resin is modified via a redistribution reaction of the polyphenylene ether in the presence of 9,9-bis(hydroxyaryl)fluorene, the composition further includes (d) a brominated epoxy resin

Also, the present invention provides a copper laminate formed by laminating the composite substrate and a copper foil, followed by heat/pressure forming.

### DETAILED DESCRIPTION OF THE INVENTION

Hereinafter, the present invention will be described in detail.

A resin composition for a printed circuit board (PCB) of the present invention includes a polyphenylene ether resin modified via a redistribution reaction of polyphenylene ether in the presence of 9,9-bis(hydroxyaryl)fluorene or 9,10-dihydro-9-oxa-10-(dihydroxyaryl)-10-phosphaphenanthrene 10-oxide. Specifically, the resin composition for the printed circuit board (PCB) includes a polyphenylene ether resin modified to have a low molecular weight via a redistribution reaction of polyphenylene ether having high molecular weight with a compound, such as 9,9-bis(hydroxyaryl)fluorene or 9,10-dihydro-9-oxa-10-(dihydroxyaryl)-10-phosphaphenanthrene 10-oxide.

Conventionally, in modifying high molecular weight polyphenylene ether into a low molecular weight polyphenylene ether resin, a compound, such as a phenol derivative or bisphenol A, has been usually used. In this case, rotation in a molecular structure may occur, thereby reducing permittivity.

However, in the present invention, instead of a conventionally used compound such as a phenol derivative or bisphenol A, 9,9-bis(hydroxyaryl)fluorene or 9,10-dihydro-9-oxa-10-(dihydroxyaryl)-10-phosphaphenanthrene 10-oxide is used to modify high molecular weight polyphenylene ether into a low molecular weight polyphenylene ether resin, thereby preventing rotation in a molecular structure while introducing many hydrophobic bicyclic hydrocarbon groups. Accordingly, it is possible to reduce the occurrence of electronic polarization, thereby decreasing permittivity. Also, compared to the conventionally used phenol derivative or bisphenol A, 9,9-bis(hydroxyaryl)fluorene and 9,10-dihydro-9-oxa-10-(dihydroxyaryl)-10-phosphaphenanthrene 10-oxide has a bulky molecular structure and high crystallinity. Thus, a polyphenylene ether resin modified to have a low molecular weight may have a high glass transition temperature. Also, through improvement of a dielectric property, a PCB of low permittivity and low loss may be achieved, and the increase of hydrophobic groups may increase moisture absorption. Also, a cross-linking property may be improved, thereby improving heat resistance and chemical resistance.

Therefore, a composite substrate and a copper laminate, which are fabricated by using a resin composition of the present invention, have an advantage in that the physical properties, such as formability, processibility, dielectric property, heat resistance, adhesive strength, etc., are improved.

Also, since 9,10-dihydro-9-oxa-10-(dihydroxyaryl)-10-phosphaphenanthrene 10-oxide is self-extinguishing due to phosphorous included in the molecules, a polyphenylene ether resin modified by using the material may be flame retardant. Therefore, even though the resin composition of the present invention does not include an additional flame retardant material, a composite substrate and a copper laminate fabricated by using the same may have high flame retardancy.

A resin composition for a PCB of the present invention may include: 10 to 60 parts by weight of polyphenylene ether; 0.1 to 5 parts by weight of 9,9-bis(hydroxyaryl)fluorene or 9,10-dihydro-9-oxa-10-(dihydroxyaryl)-10-phosphaphenanthrene 10-oxide; 10 to 40 parts by weight of a dicyclopentadiene epoxy resin; and 10 to 40 parts by weight of an alkylphenol aldehyde novolak curing agent. Also, in the case when a brominated epoxy resin is further included, the brominated epoxy resin may be used in an amount of 10 to 40 parts by weight.

In the present invention, the polyphenylene ether to be modified may be high molecular weight polyphenylene ether, and have a number-average molecular weight of 1,000 to 30,000. Also, there is no particular limitation in the polyphenylene ether, as long as the polyphenylene ether is used as a main skeleton.

Also, the 9,9-bis(hydroxyaryl)fluorene may be at least one compound selected from the group including compounds represented by Formula 3 to Formula 5.

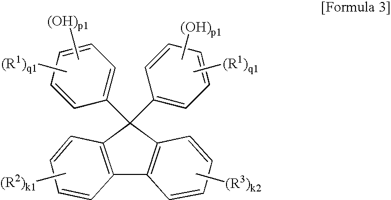

In Formula 3, each of R¹ to R³ independently represents a C₁˜C₆ alkyl group, p1 is an integer ranging from 1 to 5, q1 is an integer ranging from 0 to 4, p1+q1 is an integer equal to or less than 5, and each of k1 and k2 is independently an integer ranging from 0 to 4.

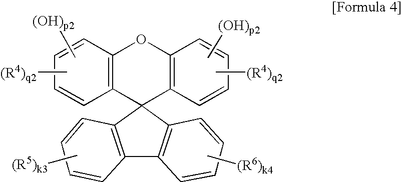

In Formula 4, each of R⁴ to R⁶ independently represents a C₁˜C₆ alkyl group, p2 is an integer ranging from 1 to 4, q2 is an integer ranging from 0 to 3, p2+q2 is an integer equal to or less than 4, and each of k3 and k4 is independently an integer ranging from 0 to 4.

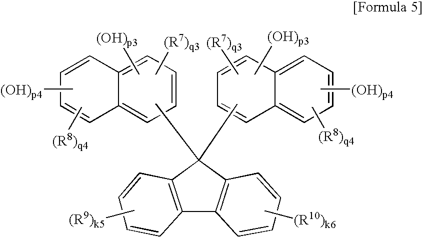

In Formula 5, each of R⁷ to R¹⁰ independently represents a C₁˜C₆ alkyl group, p3 is an integer ranging from 1 to 3, p4 is an integer ranging from 0 to 4, each of q3 and q4 is independently an integer ranging from 0 to 2, p3+q3 is an integer equal to or less than 3, p4+q4 is an integer equal to or less than 4, and each of k5 and k6 is independently an integer ranging from 0 to 4.

Also, the 9,10-dihydro-9-oxa-10-(dihydroxyaryl)-10-phosphaphenanthrene 10-oxide may be at least one compound selected from the group including compounds represented by Formula 6 and Formula 7.

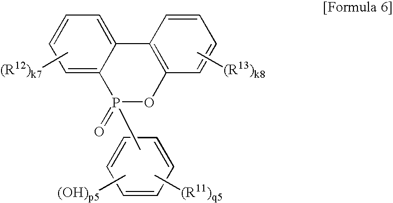

In Formula 6, each of R¹¹ to R¹³ independently represents a C₁˜C₆ alkyl group, p5 is 2, q5 is an integer ranging from 0 to 3, and each of k7 and k8 is independently an integer ranging from 0 to 4.

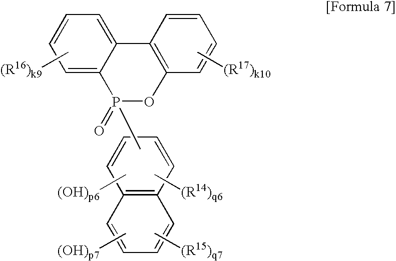

In Formula 7, each of R¹⁴ to R¹⁷ independently represents a C₁˜C₆ alkyl group, each of p6 and p7 is independently an integer ranging from 0 to 2, p6+p7 is 2, p6+q6 is an integer equal to or less than 3, p7+q7 is an integer equal to or less than 4, and each of k9 and k10 is independently an integer ranging from 0 to 4.

Also, (a) the redistribution reaction of polyphenylene ether in the presence of 9,9-bis(hydroxyaryl)fluorene or 9,10-dihydro-9-oxa-10-(dihydroxyaryl)-10-phosphaphenanthrene 10-oxide may be carried out in the presence of a radical initiator and/or a catalyst.

The radical initiator and the catalyst may include a conventional material known in the art. Examples of the radical initiator may include, but are not limited to, t-butylperoxy isopropylmonocarbonate, t-butylperoxy 2-ethylhexylcarbonate, benzoyl peroxide, acetyl peroxide, di-t-butyl peroxide, t-butyl peroxylaurate, t-butylperoxybenzoate, etc. The radical initiator may be used in an amount of 0.1 to 5 parts by weight, based on 10 to 60 parts by weight of polyphenylene ether.

Also, non-limiting examples of the catalyst include cobalt naphthanate. The catalyst may be used in an amount of 0.001 to 0.5 parts by weight, based on 10 to 60 parts by weight of polyphenylene ether.

A method of synthesizing a polyphenylene ether resin modified by a redistribution reaction of polyphenylene ether is not particularly limited, and a conventional method known in the art may be applied thereto. For example, a modified polyphenylene ether resin may be obtained by mixing polyphenylene ether with 9,9-bis(hydroxyaryl)fluorene or 9,10-dihydro-9-oxa-10-(dihydroxyaryl)-10-phosphaphenanthrene 10-oxide, and a radical initiator in the presence of a solvent or without a solvent, and heating the mixture. Herein, as the solvent, a hydrocarbon-based solvent, such as benzene, toluene, etc., may be used, but the present invention is not limited thereto. Also, the reaction temperature and reaction time may be appropriately adjusted according to number-average molecular weight of a polyphenylene ether resin to obtain through the reaction. For examples, the reaction may be carried out within a range of 60 to 200° C. for 10 minutes to 10 hours, but the present invention is not limited thereto.

In the present invention, (b) the dicyclopentadiene epoxy resin represented by Formula 1, which is a multi-functional resin, has a hydrophobic bicyclic hydrocarbon group, and thus reduces the occurrence of electronic polarization, thereby reducing the permittivity of a copper laminate.

The dicyclopentadiene epoxy resin represented by Formula 1 preferably has an epoxy equivalent of 200 to 500. If the epoxy equivalent is out of the above described range, the dicyclopentadiene epoxy resin may cause some problems, such as lack of strength in a substrate, reduction of heat resistance, occurrence of a foaming phenomenon on the surface of a prepreg.

Also, in the present invention, the dicyclopentadiene epoxy resin represented by Formula 1 is preferably included in an amount of 10 to 40 parts by weight, based on 10 to 60 parts by weight of polyphenylene ether. If the content of the dicyclopentadiene epoxy resin is out of the above described range, an effect of reducing permittivity may be not achieved, or formability may be reduced.

In the present invention, as an epoxy curing agent, (c) the alkylphenol aldehyde novolak epoxy curing agent represented by Formula 2 is used. Therefore, it is possible to significantly improve the dielectric property and heat resistance of a cured resin, compared to a conventionally used material, such as a dicyandiamide curing agent, or an acid anhydride curing agent.

Examples of the alkylphenol aldehyde novolak epoxy curing agent represented by Formula 2 include, but are not limited to, para-t-butylphenol acetaldehyde novolak, para-t-butylphenol formaldehyde novolak, para-t-butylphenol propionaldehyde novolak, para-methylphenol acetaldehyde novolak, or para-t-octylphenol acetaldehyde novolak. Also, the epoxy curing agents may be used alone or in combination.

In the present invention, the alkylphenol aldehyde novolak epoxy curing agent represented by Formula 2 preferably has a hydroxyl group equivalent of 100 to 1,000. If the equivalent is less than 100, the dielectric property is not significantly improved. On the other hand, if the equivalent is greater than 1,000, a cured polymer may have reduced heat resistance due to a decrease of crosslinking density. In the present invention, the ‘hydroxyl group equivalent’ indicates the molecular weight of hydroxides per one hydroxyl group.

Also, the alkylphenol aldehyde novolak epoxy curing agent represented by Formula 2 is preferably included in an amount of 10 to 40 parts by weight, based on 10 to 60 parts by weight of polyphenylene ether. If the content is less than 10 parts by weight, crosslinking density of a cured resin may be reduced, thereby reducing the strength and heat resistance. On the other hand, if the content is greater than 40 parts by weight, flowability may be reduced, thereby causing difficulty in a forming process.

In the present invention, (d) the brominated epoxy resin may improve flame retardancy. The brominated epoxy resin has an epoxy equivalent of 100 to 1,000, and examples of the brominated epoxy resin include, but are not limited to, a brominated bisphenol A type epoxy resin, a brominated bisphenol F type epoxy resin, a brominated bisphenol S type epoxy resin, a brominated phenol novolak epoxy resin, a brominated cresol novolak epoxy resin, a brominated cycloalipatic epoxy resin, a biphenyl type epoxy resin, or a multi-functional amine epoxy resin, etc. Also, the brominated epoxy resins may be used alone or in combination.

In the present invention, the ‘epoxy equivalent’ indicates the molecular weight of an epoxy resin per one epoxy group. It is not preferable that the brominated epoxy resin has an epoxy equivalent of less than 100 or greater than 1,000 because the brominated epoxy resin having an epoxy equivalent of less than 100 may cause problems, such as lack of strength in a substrate and reduction of heat resistance, and the brominated epoxy resin having an epoxy equivalent of greater than 1,000 may cause a problem, such as the occurrence of a foaming phenomenon on the surface of a prepreg, etc.

Also, the brominated epoxy resin preferably includes bromine in an amount of 20 to 50 wt %, in consideration of physical properties, such as flame retardancy, etc. Herein, ‘the content of the bromine’ is defined by content %, based on a resin solid content

The brominated epoxy resin is preferably included in an amount of 10 to 40 parts by weight, based on 10 to 60 parts by weight of polyphenylene ether. If the content is less than 10 parts by weight, an effect of improving flame retardancy is not significantly achieved, and if the content is greater than 40 parts by weight, a problem, such as the occurrence of a foaming phenomenon on the surface of a prepreg, may be caused.

The resin composition for the PCB in the present invention may further include (e) a curing accelerator. As the curing accelerator, an imidazole curing accelerator is preferably used in consideration of a curing speed, and more preferably, 2-ethyl-4-methyl imidazole or 2-methyl imidazole may be used.

Also, the curing accelerator is preferably included in an amount of 0.01 to 1 part by weight, based on 10 to 60 parts by weight of polyphenylene ether. If the curing accelerator is included in an amount of less than 0.01 parts by weight, curing may not be carried out or requires a high temperature or a long time. On the other hand, if the curing accelerator is included in an amount of greater than 1 part by weight, a problem may occur in the storage stability of a resin composition, or the properties of a cured resin may be deteriorated.

The resin composition for the PCB in the present invention may further include an additive, such as inorganic filler, besides the above mentioned components. Examples of the inorganic filler may include silica, alumina, aluminum hydroxide, calcium carbonate, clay, talc, silicon nitride, boron nitride, titanium oxide, barium titanate, or titanate, etc. However, the present invention is not limited thereto.

The resin composition for the PCB in the present invention may be prepared by uniformly mixing a modified polyphenylene ether resin, a dicyclopentadiene epoxy resin represented by Formula 1, and an alkylphenol aldehyde novolak curing agent represented by Formula 2 (optionally, a brominated epoxy resin, and an additional additive).

Meanwhile, a composite substrate of the present invention is fabricated by coating or impregnating the substrate with the PCB resin composition according to the present invention, followed by drying. Preferably, the composite substrate is for a PCB.

Herein, the drying may be carried out within a range of 20˜200° C., but the present invention is not limited thereto.

The substrate is at least one selected from the group including glass fabric, glass fiber non-woven fabric, polyamide fabric, polyamide fiber non-woven fabric, polyester fabric, and polyester fiber non-woven fabric. Herein, the composite substrate is preferably a prepreg for a PCB.

Also, the substrate may be at least one selected from the group including a glass plate, a polymer film, and a metal plate, but the present invention is not limited thereto. Also, as the polymer film and the metal plate, a film including a conventional polymer known in the art, and a plate including a conventional metal or alloy known in the art may be used, respectively, with no particular limitation. Herein, when the metal plate is a copper foil, a composite substrate formed by coating the resin composition according to the present invention on the copper foil, followed by drying, may be used as a copper laminate.

The coating may be carried out by using a conventional coating method known in the art, and non-limiting examples of the coating method may include lip coating, die coating, roll coating, comma coating, or a mixed method thereof.

Also, the composite substrate of the present invention may be fabricated by laminating at least two composite substrates, in which each substrate is coated or impregnated with the resin composition according to the present invention, followed by drying.

In the present invention, a copper laminate is formed by laminating the composite substrate and copper foil according to the present invention and subjecting the laminated materials to a heat/pressure forming treatment. Herein, the composite substrate is preferably a prepreg. Also, in forming the laminate, the heating/pressuring conditions may be appropriately adjusted according to the thickness of a fabricated laminate, the kind of the resin composition according to the present invention, etc.

Reference will now be made in detail to the preferred embodiments of the present invention. However, the following examples are illustrative only, and the scope of the present invention is not limited thereto.

### EXAMPLE 1

(Preparation of a Resin Composition)

As noted in Table 1, 30 parts by weight of polyphenylene ether (Nornyl PX9701, available from GE) having a number-average molecular weight of 2,000 to 20,000, 0.3 parts by weight of 9,9-bis(3-methyl-4-hydroxyphenyl)fluorene (BCF), 0.27 parts by weight of t-butylperoxy isopropylmonocarbonate (PB-I, available from Nippon Oil & Fats) as a radical initiator, and 0.008 parts by weight of cobalt naphthanate having a cobalt content of 6% as a catalyst were mixed, and were subjected to a reaction at 90° C. for 60 minutes to provide a polyphenylene ether resin modified to have a number-average molecular weight of 12,500.

To the modified polyphenylene ether resin, 25 parts by weight of a brominated epoxy resin (YDB-400, available from KukDo Chemical) having a bromine content of 20 to 50%, 21 parts by weight of a dicyclopentadiene epoxy resin (HP-7200, available from Epiclon), 24 parts by weight of para-t-butylphenol acetaldehyde novolak as an alkylphenol novolak curing agent, and 0.3 parts by weight of 2-ethyl-4-methyl imidazole as a curing accelerator were added, followed by stirring for about 1 hour to prepare a resin composition.

(Fabrication of a Copper Laminate)

The prepared resin composition was impregnated in glass fiber (7628 or 2116, available from Baotek), followed by drying for 5 to 10 minutes in a dryer at 150° C., to obtain a prepreg having a resin content of 43 to 52%.

8 obtained prepregs were layered, and a copper foil with a thickness of 35 μm was laminated on each of the top and bottom. Then, a forming process was carried out for 120 minutes at 180° C. under 40 kgf/cm² to obtain a double-sided copper laminate having a thickness of 1.0 to 1.6 mm.

### EXAMPLE 2

A resin composition and a copper laminate were obtained in the same manner as described in Example 1, except that 18 parts by weight of a brominated epoxy resin (YDB-400, available from KukDo Chemical), 26 parts by weight of a dicyclopentadiene epoxy resin (HP-7200, available from Epiclon), and 26 parts by weight of para-t-butylphenol acetaldehyde novolak as an alkylphenol novolak curing agent were used, as noted in Table 1.

### EXAMPLE 3

A resin composition and a copper laminate were obtained in the same manner as described in Example 1, except that benzoyl peroxide was used as a radical initiator, instead of t-butylperoxy isopropylmonocarbonate (PB-I, available from Nippon Oil & Fats) as noted in Table 1.

### EXAMPLE 4

A resin composition and a copper laminate were obtained in the same manner as described in Example 1, except that benzoyl peroxide was used as a radical initiator, instead of t-butylperoxy isopropylmonocarbonate (PB-I, available from Nippon Oil & Fats), and 18 parts by weight of a brominated epoxy resin (YDB-400, available from KukDo Chemical), 26 parts by weight of a dicyclopentadiene epoxy resin (HP-7200, available from Epiclon), and 26 parts by weight of para-t-butylphenol acetaldehyde novolak as an alkylphenol novolak curing agent were used, as noted in Table 1.

### COMPARATIVE EXAMPLE 1

A resin composition and a copper laminate were obtained in the same manner as described in Example 1, except that bisphenol A was used, instead of 9,9-bis(3-methyl-4-hydroxyphenyl)fluorene as noted in Table 1.

### COMPARATIVE EXAMPLE 2

A resin composition and a copper laminate were obtained in the same manner as described in Example 4, except that bisphenol A was used, instead of 9,9-bis(3-methyl-4-hydroxyphenyl)fluorene as noted in Table 1.

### COMPARATIVE EXAMPLE 3

A copper laminate was obtained in the same manner as described in Example 1, except that 36 parts by weight of a brominated epoxy resin (YDB-400, available from KukDo Chemical) having a bromine content of 20 to 50%, 30 parts by weight of a dicyclopentadiene epoxy resin (HP-7200, available from Epiclon), 34 parts by weight of para-t-butylphenol acetaldehyde novolak as an alkylphenol novolak curing agent, 0.5 parts by weight of 2-ethyl-4-methyl imidazole as a curing accelerator were mixed as noted in Table 1, followed by stirring for about 1 hour to prepare a resin composition.

TABLE 1

| | Example | | | | Comp. Exp. | | |
|---|---|---|---|---|---|---|---|
| Components | 1 | 2 | 3 | 4 | 1 | 2 | 3 |
| Polyphenylene | 30 | 30 | 30 | 30 | 30 | 30 | — |
| ether (PPE) | | | | | | | |
| Bisphenol A | — | — | — | — | 0.3 | 0.3 | — |
| 9,9-bis(3-methyl- | 0.3 | 0.3 | 0.3 | 0.3 | — | — | — |
| 4- | | | | | | | |
| hydroxyphenyl)fluorene | | | | | | | |
| (BCF) | | | | | | | |
| PB-I (radical | 0.27 | 0.27 | — | — | 0.27 | — | — |
| initiator) | | | | | | | |
| benzoyl peroxide | — | — | 0.27 | 0.27 | — | 0.27 | — |
| (radical | | | | | | | |
| initiator) | | | | | | | |
| cobalt naphthanate | 0.008 | 0.008 | 0.008 | 0.008 | 0.008 | 0.008 | — |
| (catalyst) | | | | | | | |
| Molecular weight | 12500 | 12500 | 6400 | 6400 | 11000 | 2800 | — |
| of modified | | | | | | | |
| polyphenylene | | | | | | | |
| ether | | | | | | | |
| Brominated epoxy | 25 | 18 | 25 | 18 | 25 | 18 | 36 |
| resin | | | | | | | |
| dicyclopentadiene | 21 | 26 | 21 | 26 | 21 | 26 | 30 |
| epoxy resin | | | | | | | |
| alkylphenol | 24 | 26 | 24 | 26 | 24 | 26 | 34 |
| novolak curing | | | | | | | |
| agent | | | | | | | |
| 2-ethyl-4-methyl | 0.3 | 0.3 | 0.3 | 0.3 | 0.3 | 0.3 | 0.5 |
| imidazole (curing | | | | | | | |
| accelerator) | | | | | | | |

### EXPERIMENTAL EXAMPLE 1

The physical property of each of the copper laminates obtained from Examples 1 to 4 and Comparative Examples 1 to 3 was tested by the following method. The results are shown in the following Table 2.

(1) Glass transition temperature (T_{g}): The measurement was carried out by using DSC (Differential Scanning Calorimeter), after etching and removing a copper foil layer of a copper laminate.

(2) Permittivity: The measurement was carried out by using a Material Analyzer in accordance with IPC TM-650. 2.5.5.1.

(3) Heat resistance of lead: Samples cut into a size of 5 cm×5 cm were fed into a solder bath at 288° C., and a time when abnormality starts to occur was measured.

(4) Adhesive strength of a copper foil: The measurement was carried out in accordance with IPC-TM-650. 2.4.8 in order to test the adhesive strength between a copper foil and an insulator.

(5) Flame retardancy: The measurement was carried out in accordance with UL 94.

TABLE 2

| | Example | | | | Comp. Exp. | | |
|---|---|---|---|---|---|---|---|
| Items | 1 | 2 | 3 | 4 | 1 | 2 | 3 |
| Glass transition | 192 | 202 | 186 | 200 | 173 | 185 | 178 |
| temperature (Tg, ° C.) | | | | | | | |
| Permittivity (R/C = | 3.6 | 3.4 | 3.6 | 3.4 | 3.7 | 3.7 | 4.1 |
| 52% at 1 MHz) | | | | | | | |
| Heat resistance of lead | 600 s | 600 s | 600 s | 600 s | 120 s | 180 s | 390 s |
| (@288) | | | | | | | |
| Adhesive strength of a | 1.4 | 1.2 | 1.5 | 1.3 | 1.1 | 0.9 | 1.5 |
| copper foil (kN/m) | | | | | | | |
| Flame retardancy | V-0 | V-0 | V-0 | V-0 | V-0 | V-0 | V-0 |

As noted in Table 2, as compared to Comparative Examples 1 and 2, in which a polyphenylene ether resin modified by a redistribution reaction of polyphenylene ether in the presence of conventional bisphenol A was used, and Comparative Example 3 in which a polyphenylene ether resin was not used, Examples 1 to 4, in which a polyphenylene ether resin modified by a redistribution reaction of polyphenylene ether in the presence of 9,9-bis(3-methyl-4-hydroxyphenyl)fluorene was used, showed improved results in physical properties such as glass transition temperature, permittivity, heat resistance, adhesive strength, etc.

### EXAMPLE 5

(Preparation of a Resin Composition)

As noted in Table 3, 30 parts by weight of polyphenylene ether (Nornyl PX9701, available from GE) having a number-average molecular weight of 2,000 to 20,000, 2 parts by weight of 9,10-dihydro-9-oxa-10-(2,5-dihydroxyphenyl)-10-phosphaphenanthrene 10-oxide (HCA-HQ, available from Sanko), 0.9 parts by weight of t-butylperoxy isopropylmonocarbonate (PB-I, available from Nippon Oil & Fats) as a radical initiator, and 0.016 parts by weight of cobalt naphthanate having a cobalt content of 6% as a catalyst were mixed, and were subjected to a reaction at 90° C. for 60 minutes to provide a polyphenylene ether resin modified to have a number-average molecular weight of 5,800.

To the modified polyphenylene ether resin, 35 parts by weight of a dicyclopentadiene epoxy resin (HP-7200, available from Epiclon), 35 parts by weight of para-t-butylphenol acetaldehyde novolak as an alkylphenol novolak curing agent, and 0.3 parts by weight of 2-ethyl-4-methyl imidazole as a curing accelerator were added, followed by stirring for about 1 hour to prepare a resin composition.

(Fabrication of a Copper Laminate)

The prepared resin composition was impregnated in glass fiber (7628 or 2116, available from Baotek), followed by drying for 5 to 10 minutes in a dryer at 150° C., to obtain a prepreg having a resin content of 43 to 52%.

8 obtained prepregs were layered, and a copper foil with a thickness of 35 μm was laminated on each of the top and bottom. Then, a forming process was carried out for 120 minutes at 180° C. under 40 kgf/cm² to obtain a double-sided copper laminate having a thickness of 1.0 to 1.6 mm.

### EXAMPLE 6

A resin composition and a copper laminate were obtained in the same manner as described in Example 5, except that 25 parts by weight of a dicyclopentadiene epoxy resin (HP-7200, available from Epiclon), and 45 parts by weight of para-t-butylphenol acetaldehyde novolak as an alkylphenol novolak curing agent were used, as noted in Table 3.

### EXAMPLE 7

A resin composition and a copper laminate were obtained in the same manner as described in Example 5, except that benzoyl peroxide was used as a radical initiator, instead of t-butylperoxy isopropylmonocarbonate (PB-I, available from Nippon Oil & Fats) as noted in Table 3.

### EXAMPLE 8

A resin composition and a copper laminate were obtained in the same manner as described in Example 5, except that benzoyl peroxide was used as a radical initiator, instead of t-butylperoxy isopropylmonocarbonate (PB-I, available from Nippon Oil & Fats), and 25 parts by weight of a dicyclopentadiene epoxy resin (HP-7200, available from Epiclon), and 45 parts by weight of para-t-butylphenol acetaldehyde novolak as an alkylphenol novolak curing agent were used, as noted in Table 3.

### COMPARATIVE EXAMPLE 4

A resin composition and a copper laminate were obtained in the same manner as described in Example 5, except that 0.3 parts by weight of bisphenol A, instead of 9,10-dihydro-9-oxa-10-(2,5-dihydroxyphenyl)-10-phosphaphenanthrene 10-oxide, was used, 0.27 parts by weight of t-butylperoxy isopropylmonocarbonate (PB-I, available from Nippon Oil & Fats) was used as a radical initiator, and 0.008 parts by weight of cobalt naphthanate having a cobalt content of 6% was used as a catalyst, as noted in Table 3.

### COMPARATIVE EXAMPLE 5

A resin composition and a copper laminate were obtained in the same manner as described in Example 8, except that 0.3 parts by weight of bisphenol A, instead of 9,10-dihydro-9-oxa-10-(2,5-dihydroxyphenyl)-10-phosphaphenanthrene 10-oxide, was used, 0.27 parts by weight of benzoyl peroxide, instead of t-butylperoxy isopropylmonocarbonate (PB-I, available from Nippon Oil & Fats), was used as a radical initiator, and 0.008 parts by weight of cobalt naphthanate having a cobalt content of 6% was used as a catalyst, as noted in Table 3.

### COMPARATIVE EXAMPLE 6

A copper laminate was obtained in the same manner as described in Example 5, except that 36 parts by weight of a brominated epoxy resin (YDB-400, available from KukDo Chemical) having a bromine content of 20 to 50%, 30 parts by weight of a dicyclopentadiene epoxy resin (HP-7200, available from Epiclon), 34 parts by weight of para-t-butylphenol acetaldehyde novolak as an alkylphenol novolak curing agent, and 0.5 parts by weight of 2-ethyl-4-methyl imidazole as a curing accelerator were mixed as noted in Table 3, followed by stirring for about 1 hour to prepare a resin composition.

TABLE 3

| | Example | | | | Comp. Exp. | | |
|---|---|---|---|---|---|---|---|
| Components | 5 | 6 | 7 | 8 | 4 | 5 | 6 |
| Polyphenylene ether | 30 | 30 | 30 | 30 | 30 | 30 | — |
| (PPE) | | | | | | | |
| Bisphenol A | — | — | — | — | 0.3 | 0.3 | — |
| 9,10-dihydro-9-oxa- | 2 | 2 | 2 | 2 | — | — | — |
| 10-(2,5- | | | | | | | |
| dihydroxyphenyl)-10- | | | | | | | |
| phosphaphenanthrene | | | | | | | |
| 10-oxide (HCA-HQ) | | | | | | | |
| PB-I (radical | 0.9 | 0.9 | — | — | 0.27 | — | — |
| initiator) | | | | | | | |
| benzoyl peroxide | — | — | 0.9 | 0.9 | — | 0.27 | — |
| (radical initiator) | | | | | | | |
| cobalt naphthanate | 0.016 | 0.016 | 0.016 | 0.016 | 0.008 | 0.008 | — |
| (catalyst) | | | | | | | |
| Molecular weight of | 5800 | 5800 | 3100 | 3100 | 11000 | 2800 | — |
| modified | | | | | | | |
| polyphenylene ether | | | | | | | |
| Brominated epoxy | — | — | — | — | — | — | 36 |
| resin | | | | | | | |
| dicyclopentadiene | 35 | 25 | 35 | 25 | 35 | 25 | 30 |
| epoxy resin | | | | | | | |
| alkylphenol novolak | 35 | 45 | 35 | 45 | 35 | 45 | 34 |
| curing agent | | | | | | | |
| 2-ethyl-4-methyl | 0.3 | 0.3 | 0.3 | 0.3 | 0.3 | 0.3 | 0.5 |
| imidazole (curing | | | | | | | |
| accelerator) | | | | | | | |

### EXPERIMENTAL EXAMPLE 2

The physical property of each of the copper laminates obtained from Examples 5 to 8 and Comparative Examples 4 to 6 was tested in the same manner as described in Experimental Example 1. The results are shown in the following Table 4.

TABLE 4

| | Example | | | | Comp. Exp. | | |
|---|---|---|---|---|---|---|---|
| Items | 5 | 6 | 7 | 8 | 4 | 5 | 6 |
| Glass transition | 196 | 202 | 191 | 201 | 176 | 186 | 178 |
| temperature (Tg, ° C.) | | | | | | | |
| Permittivity | 3.5 | 3.4 | 3.5 | 3.4 | 3.7 | 3.7 | 4.1 |
| (R/C = 52% | | | | | | | |
| at 1 MHz) | | | | | | | |
| Heat resistance of lead | 600 s | 600 s | 600 s | 600 s | 120 s | 180 s | 390 s |
| (@288) | | | | | | | |
| Adhesive strength of a | 1.4 | 1.2 | 1.5 | 1.3 | 1.1 | 0.9 | 1.5 |
| copper foil (kN/m) | | | | | | | |
| Flame retardancy | V-0 | V-0 | V-0 | V-0 | V-1 | V-1 | V-0 |

As noted in Table 4, as compared to Comparative Examples 4 and 5, in which a polyphenylene ether resin modified by a redistribution reaction of polyphenylene ether in the presence of conventional bisphenol A was used, and Comparative Example 6, in which a polyphenylene ether resin was not used, Examples 5 to 8 in which a polyphenylene ether resin modified by a redistribution reaction of polyphenylene ether in the presence of 9,10-dihydro-9-oxa-10-(2,5-dihydroxyphenyl)-10-phosphaphenanthrene 10-oxide was used, showed improved results in physical properties such as glass transition temperature, permittivity, heat resistance, adhesive strength, flame retardancy, etc.

### INDUSTRIAL APPLICABILITY

In the present invention, instead of a conventionally used bisphenol A, 9,9-bis(hydroxyaryl)fluorene or 9,10-dihydro-9-oxa-10-(dihydroxyaryl)-10-phosphaphenanthrene 10-oxide is used to carry out a redistribution reaction of polyphenylene ether. Also, when a resin composition including a polyphenylene ether resin modified by such a redistribution reaction is used, it is possible to fabricate a copper laminate having low permittivity appropriate for high speed and high frequency of a signal, as well as a relatively high glass transition temperature, high heat resistance, high adhesive strength and high flame retardancy.

Although several exemplary embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. A resin composition for a PCB, the composition comprising:
(a) a polyphenylene ether resin modified via a redistribution reaction of polyphenylene ether in the presence of 9,9-bis(hydroxyaryl)fluorene or 9,10-dihydro-9-oxa-10-(dihydroxyaryl)-10-phosphaphenanthrene 10-oxide;
(b) a dicyclopentadiene epoxy resin represented by Formula 1; and
(c) an alkylphenol aldehyde novolak curing agent represented by Formula 2,
wherein, when the polyphenylene ether resin is modified via a redistribution reaction of the polyphenylene ether in the presence of 9,9-bis(hydroxyaryl)fluorene, the composition further comprises (d) a brominated epoxy resin: 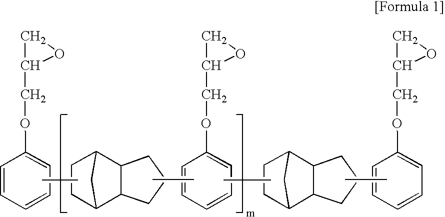
wherein m is an integer equal to or more than 0; and 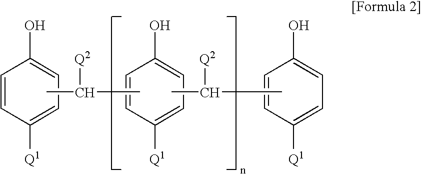
wherein Q¹ represents a C₁˜C₁₂ alkyl group, a C₅˜C₇ cycloalkyl group, or a C₆˜C₂₄ aromatic hydrocarbon group, Q² represents hydrogen or a C₁˜C₁₂ alkyl group, and n is an integer equal to or more than 0.

2. The resin composition as claimed in claim 1, which comprises 10 to 60 parts by weight of polyphenylene ether; 0.1 to 5 parts by weight of 9,9-bis(hydroxyaryl)fluorene or 9,10-dihydro-9-oxa-10-(dihydroxyaryl)-10-phosphaphenanthrene 10-oxide; 10 to 40 parts by weight of the dicyclopentadiene epoxy resin; and 10 to 40 parts by weight of the alkylphenol aldehyde novolak curing agent,
wherein, when the brominated epoxy resin is further included, the brominated epoxy resin is included in an amount of 10 to 40 parts by weight.

3. The resin composition as claimed in claim 1, wherein the 9,9-bis(hydroxyaryl)fluorene is at least one compound selected from the group including compounds represented by Formula 3 to Formula 5: 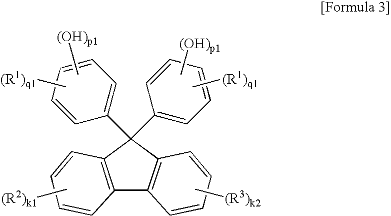
wherein each of R¹ to R³ independently represents a C₁˜C₆ alkyl group, p1 is an integer ranging from 1 to 5, q1 is an integer ranging from 0 to 4, p1+q1 is an integer equal to or less than 5, and each of k1 and k2 is independently an integer ranging from 0 to 4; 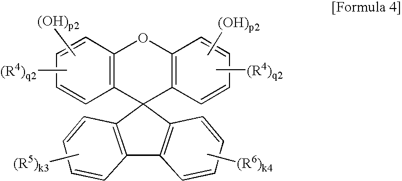
wherein each of R⁴ to R⁶ independently represents a C₁˜C₆ alkyl group, p2 is an integer ranging from 1 to 4, q2 is an integer ranging from 0 to 3, p2+q2 is an integer equal to or less than 4, and each of k3 and k4 is independently an integer ranging from 0 to 4; and 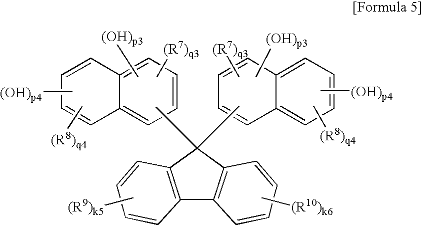
wherein each of R⁷ to R¹⁰ independently represents a C₁˜C₆ alkyl group, p3 is an integer ranging from 1 to 3, p4 is an integer ranging from 0 to 4, each of q3 and q4 is independently an integer ranging from 0 to 2, p3+q3 is an integer equal to or less than 3, p4+q4 is an integer equal to or less than 4, and each of k5 and k6 is independently an integer ranging from 0 to 4.

4. The resin composition as claimed in claim 1, wherein the 9,10-dihydro-9-oxa-10-(dihydroxyaryl)-10-phosphaphenanthrene 10-oxide is at least one compound selected from the group including compounds represented by Formula 6 and Formula 7: 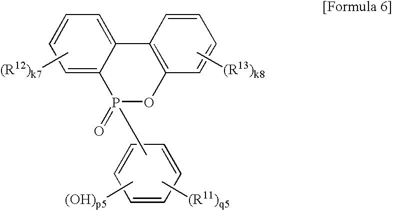
wherein each of R¹¹ to R¹³ independently represents a C₁˜C₆ alkyl group, p5 is 2, q5 is an integer ranging from 0 to 3, and each of k7 and k8 is independently an integer ranging from 0 to 4; and 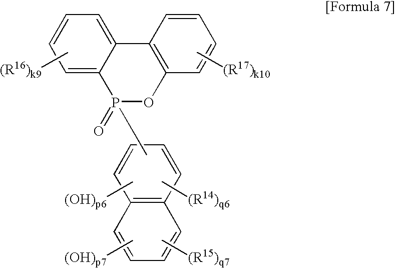
wherein each of R¹⁴ to R¹⁷ independently represents a C₁˜C₆ alkyl group, each of p6 and p7 is independently an integer ranging from 0 to 2, p6+p7 is 2, p6+q6 is an integer equal to or less than 3, p7+q7 is an integer equal to or less than 4, and each of k9 and k10 is independently an integer ranging from 0 to 4.

5. The resin composition as claimed in claim 1, wherein the redistribution reaction is carried out in the presence of a radical initiator and/or a catalyst.

6. The resin composition as claimed in claim 1, wherein (b) the dicyclopentadiene epoxy resin has an epoxy equivalent of 200 to 500.

7. The resin composition as claimed in claim 1, wherein (c) the alkylphenol aldehyde novolak curing agent has a hydroxyl group equivalent of 100˜1,000.

8. The resin composition as claimed in claim 1, wherein (c) the alkylphenol aldehyde novolak curing agent is at least one selected from the group including para-t-butylphenol acetaldehyde novolak, para-t-butylphenol formaldehyde novolak, para-t-butylphenol propionaldehyde novolak, para-methylphenol acetaldehyde novolak, and para-t-octylphenol acetaldehyde novolak.

9. The resin composition as claimed in claim 1, wherein (d) the brominated epoxy resin has an epoxy equivalent of 100-1,000, and is at least one selected from the group including a brominated bisphenol A type epoxy resin, a brominated bisphenol F type epoxy resin, a brominated bisphenol S type epoxy resin, a brominated phenol novolak epoxy resin, a brominated cresol novolak epoxy resin, a brominated cycloalipatic epoxy resin, a biphenyl type epoxy resin, or a multi-functional amine epoxy resin.

10. The resin composition as claimed in claim 1, further comprising (e) a curing accelerator.

11. The resin composition as claimed in claim 10, wherein (e) the curing accelerator is an imidazole curing accelerator.

12. A composite substrate formed by coating or impregnating a substrate with a resin composition for a PCB, followed by drying, the resin composition for the PCB comprising:
(a) a polyphenylene ether resin modified via a redistribution reaction of polyphenylene ether in the presence of 9,9-bis(hydroxyaryl)fluorene or 9,10-dihydro-9-oxa-10-(dihydroxyaryl)-10-phosphaphenanthrene 10-oxide;
(b) a dicyclopentadiene epoxy resin represented by Formula 1; and
(c) an alkylphenol aldehyde novolak curing agent represented by Formula 2,
wherein, when the polyphenylene ether resin is modified via a redistribution reaction of the polyphenylene ether in the presence of 9,9-bis(hydroxyaryl)fluorene, the composition further comprises (d) a brominated epoxy resin: 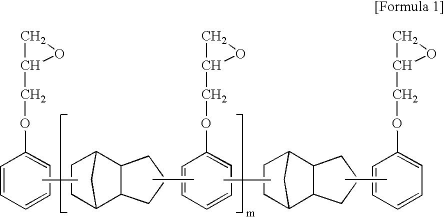
wherein m is an integer equal to or more than 0; and 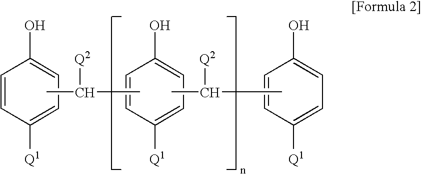
wherein Q¹ represents a C₁˜C₁₂ alkyl group, a C₅˜C₇ cycloalkyl group, or a C₆˜C₂₄ aromatic hydrocarbon group, Q² represents hydrogen or a C₁˜C₁₂ alkyl group, and n is an integer equal to or more than 0.

13. The composite substrate as claimed in claim 12, wherein the substrate is at least one selected from the group including glass fabric, glass fiber non-woven fabric, polyamide fabric, polyamide fiber non-woven fabric, polyester fabric, and polyester fiber non-woven fabric, and the composite substrate is a prepreg for the PCB.

14. The composite substrate as claimed in claim 12, wherein the substrate is at least one selected from the group including a glass plate, a polymer film, and a metal plate.

15. The composite substrate as claimed in claim 12, which comprises 10 to 60 parts by weight of polyphenylene ether, 0.1 to 5 parts by weight of 9,9-bis(hydroxyaryl)fluorene or 9,10-dihydro-9-oxa-10-(dihydroxyaryl)-10-phosphaphenanthrene 10-oxide, 10 to 40 parts by weight of the dicyclopentadiene epoxy resin, and 10 to 40 parts by weight of the alkylphenol aldehyde novolak curing agent,
wherein, when the brominated epoxy resin is further included, the brominated epoxy resin is included in an amount of 10 to 40 parts by weight.

16. The composite substrate as claimed in claim 12, wherein the 9,9-bis(hydroxyaryl)fluorene is at least one compound selected from the group including compounds represented by Formula 3 to Formula 5: 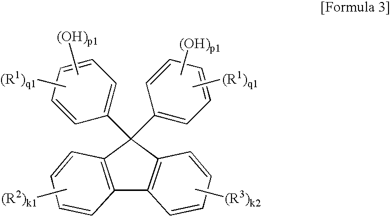
wherein each of R¹ to R³ independently represents a C₁˜C₆ alkyl group, p1 is an integer ranging from 1 to 5, q1 is an integer ranging from 0 to 4, p1+q1 is an integer equal to or less than 5, and each of k1 and k2 is independently an integer ranging from 0 to 4; 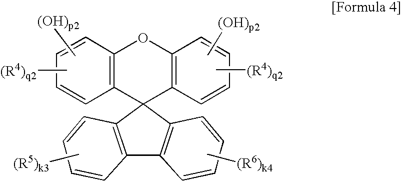
wherein each of R⁴ to R⁶ independently represents a C₁˜C₆ alkyl group, p2 is an integer ranging from 1 to 4, q2 is an integer ranging from 0 to 3, p2+q2 is an integer equal to or less than 4, and each of k3 and k4 is independently an integer ranging from 0 to 4; and 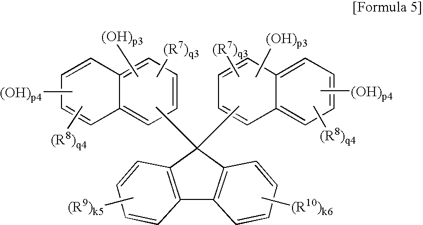
wherein each of R⁷ to R¹⁰ independently represents a C₁˜C₆ alkyl group, p3 is an integer ranging from 1 to 3, p4 is an integer ranging from 0 to 4, each of q3 and q4 is independently an integer ranging from 0 to 2, p3+q3 is an integer equal to or less than 3, p4+q4 is an integer equal to or less than 4, and each of k5 and k6 is independently an integer ranging from 0 to 4.

17. The composite substrate as claimed in claim 12, wherein the 9,10-dihydro-9-oxa-10-(dihydroxyaryl)-10-phosphaphenanthrene 10-oxide is at least one compound selected from the group including compounds represented by Formula 6 and Formula 7: 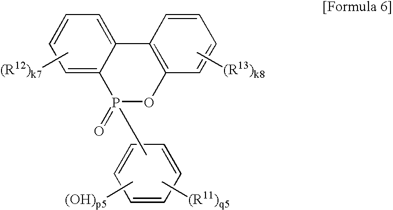
wherein each of R¹¹ to R¹³ independently represents a C₁˜C₆ alkyl group, p5 is 2, q5 is an integer ranging from 0 to 3, and each of k7 and k8 is independently an integer ranging from 0 to 4; and 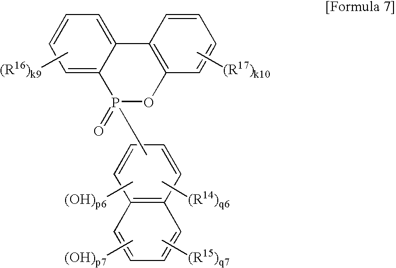
wherein each of R¹⁴ to R¹⁷ independently represents a C₁˜C₆ alkyl group, each of p6 and p7 is independently an integer ranging from 0 to 2, p6+p7 is 2, p6+q6 is an integer equal to or less than 3, p7+q7 is an integer equal to or less than 4, and each of k9 and k10 is independently an integer ranging from 0 to 4.

18. The composite substrate as claimed in claim 12, wherein the redistribution reaction is carried out in the presence of a radical initiator and/or a catalyst.

19. The composite substrate as claimed in claim 12, wherein (b) the dicyclopentadiene epoxy resin has an epoxy equivalent of 200 to 500.

20. The composite substrate as claimed in claim 12, wherein (c) the alkylphenol aldehyde novolak curing agent has a hydroxyl group equivalent of 100˜1,000.

21. The composite substrate as claimed in claim 12, wherein (c) the alkylphenol aldehyde novolak curing agent is at least one selected from the group including para-t-butylphenol acetaldehyde novolak, para-t-butylphenol formaldehyde novolak, para-t-butylphenol propionaldehyde novolak, para-methylphenol acetaldehyde novolak, and para-t-octylphenol acetaldehyde novolak.

22. The composite substrate as claimed in claim 12, wherein (d) the brominated epoxy resin has an epoxy equivalent of 100˜1,000, and is at least one selected from the group including a brominated bisphenol A type epoxy resin, a brominated bisphenol F type epoxy resin, a brominated bisphenol S type epoxy resin, a brominated phenol novolak epoxy resin, a brominated cresol novolak epoxy resin, a brominated cycloalipatic epoxy resin, a biphenyl type epoxy resin, or a multi-functional amine epoxy resin.

23. The composite substrate as claimed in claim 12, further comprising (e) a curing accelerator.

24. A copper laminate formed by laminating the composite substrate as claimed in claim 12 and a copper foil, followed by heat/pressure forming.
